(19) United States
(12) Patent Application Publication
(10) Pub. No.: US 2003/0126973 A1
(43) Pub. Date: Jul. 10, 2003

(54) Data processing method of a karaoke system based on a network system

(76) Inventor: Shao-Tsu Kung, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,205

(22) Filed: Mar. 28, 2002

(30) Foreign Application Priority Data
Jan. 7, 2002 (TW) 091100118

(51) Int. Cl. G10H 1/36

(52) U.S. Cl. 84/610

(57) ABSTRACT

A data processing method utilized in network system includes: utilizing a first transmitter to transmit an audio signal and a selection signal to a network receiver in a server, selecting a corresponding accompaniment signal from a database according to the selection signal, mixing the audio signal and the accompaniment signal with a mixer, utilizing a second transmitter to transmit a login signal and an identification signal corresponding to a second terminal to the network receiver in the server, comparing the login signal and a predetermined account number, and utilizing a network transmitter to transmit a music signal to the second terminal according to the identification signal if the login signal is the same as the predetermined account.

### BACKGROUND OF THE INVENTION

1. Field of the Invention

The present invention relates to a data processing method of a karaoke system based on a network system, and more particularly, to a method that uses a mixer of a server to mix an audio signal of users and an accompaniment signal inside a database of the server.

2. Description of the Prior Art

In this busy industry and commerce society, users always like to get together to have fun and relax with friends. Activities such as karaoke are good ways for people to get together and enjoy singing. However, since people are busy with work, it is difficult for all people to meet at the same time and place. Although network systems are developed nowadays, they still cannot allow users to enjoy karaoke without being in the same location.

Please refer to FIG. 1. FIG. 1 is a perspective view of the prior art network system 10 in which users use the network system 10 to enjoy karaoke. As shown in FIG. 1, when users use the prior art network system to enjoy karaoke, users must first dialup to connect a terminal 12 (such as a cellular phone or personal computer) to a server 14 through the network system 10. After connecting to the server 14, users can download electronic accompaniment signals (such as numbered musical notation data) 18 stored inside the server 14 to the terminal 12. A converter 22 inside the terminal 12 can convert the accompaniment signals 18 into an accompaniment melody 24 and play the accompaniment melody 24, so that users can sing by using the accompaniment melody 24 as background music.

In prior art technology, although the server 14 has stored many accompaniment signals 18 for users to download, users still cannot enjoy singing together with friends without being together in the same location. That means, when users want to sing with friends, all people must match the meeting time and place. Therefore, the prior art network system 10 is inconvenient for users. The prior art network system 10 is unable to simultaneously provide karaoke service to many users when users are not in the same place, so that users cannot enjoy singing with friends.

Therefore, in the 3G (third generation) mobile communication age, it is an important research target to use wide communication bandwidth and internet service to develop a network karaoke system so as to allow users to enjoy singing with friends without having to be together in the same location.

### SUMMARY OF INVENTION

It is therefore a primary objective of the claimed invention to provide a data processing method of a karaoke system based on a network system, and more particularly, to a method that uses a mixer of a server to mix an audio signal of users and an accompaniment signal inside a database of the server.

The claimed invention, briefly summarized, discloses a data processing method utilized in a network system. The data processing method includes: utilizing a first transmitter to transmit an audio signal and a selection signal to a network receiver in a server, selecting a corresponding accompaniment signal from a database according to the selection signal, mixing the audio signal and the accompaniment signal with a mixer, utilizing a second transmitter to transmit a login signal and an identification signal corresponding to a second terminal to the network receiver in the server, comparing the login signal and a predetermined account number, and utilizing a network transmitter to transmit a music signal to the second terminal according to the identification signal if the login signal is the same as the predetermined account.

It is an advantage of the claimed invention that the claimed invention provides the music mixing service and the image mixing service. Users can enjoy karaoke fun without limitations of time, traffic, and place.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a perspective view of the prior art network system in which users use network system to enjoy karaoke.

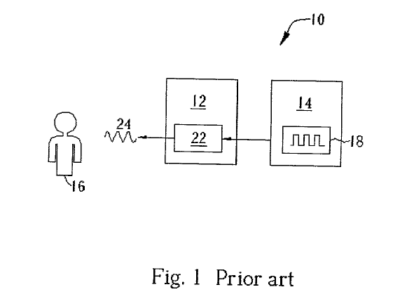

FIG. 2 is a perspective view of the present invention network system that provides karaoke service.

FIG. 3 is a perspective view of an image processing method according to the present invention.

### DETAILED DESCRIPTION

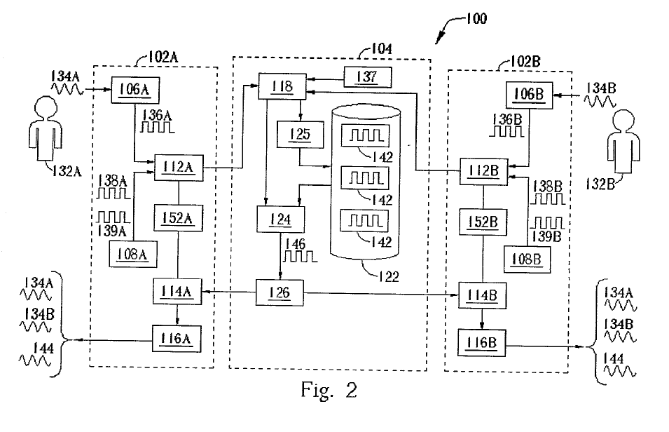

Please refer to FIG. 2. FIG. 2 is a perspective view of a present invention network system 100 that provides karaoke service. As shown in FIG. 2, the present invention network system 100 comprises a plurality of terminals (such as cellular phones, personal computers, or information appliances) and a server 104. Although FIG. 2 shows only two terminals 102A and 102B, the present invention is not limited to that. The present invention method can be used in network system that has any quantity of terminals. The function of the terminals 102A and 102B are same. Using terminal 102A as an example, the terminal 102a comprises a microphone 106A, a controller 108A, a transmitter 112A, a receiver 114A, and a speaker 116A. The terminal 102B comprises a microphone 106B, a controller 108B, a transmitter 112B, a receiver 114B, and a speaker 116B. The server 104 comprises a network receiver 118, a database 122, a mixer 124, a selection circuit 125, and a network transmitter 126. The terminals shown in FIG. 2 are two cellular phones 102A and 102B. That means, the present invention can be used by several terminals which are located in different places. All of these terminals connect to the server 104 through the network. The transmitters 112A, 112B of cellular phones 102A, 102B transmit signals to server 104 through wireless transmission. Similarly, the network transmitter 126 also uses wireless transmission to transmit signals to the cellular phones 102A, 102B. If the terminals are personal computers, the terminals and server 104 transmit signals to each other through network cords.

The following uses the cellular phone 102A as an example to illustrate the function of the terminals. The microphone 106A is used to receive an acoustic wave 134A generated by a user of the cellular phone 102A and then convert the acoustic wave 134A into a corresponding audio signal 136A. The controller 108 provides a plurality of input buttons or other input devices (such as a contact panel) as a human-machine interface. The controller 108 can generate a corresponding selection signal 138 according to an instruction inputted by a user 132A of the cellular phone 102A. The cellular phone 102A includes an identification signal 152A for identifying the cellular phone 102A by each terminal in the network system 100. The transmitter 112A is used to transmit signals to server 104. The receiver 114A is used to receive signals transmitted from the network transmitter 126. The speaker 116 converts the signals received by the receiver 114 into acoustic waves. Similarly, the cellular phone 102B also has an identification signal 152B. The function of the cellular 102B is similar to the function of the cellular phone 102A. In the server 104, the network receiver 118 is used to receive signals transmitted from the cellular phones 102A, 102B. The database 122 is used to store a plurality of electronic accompaniment signals 142. The selection circuit 125 can select a specific accompaniment signal 142 according to the signal received by the network receiver 118. Each accompaniment signal 142 corresponds to an accompaniment melody, such as the background music of the karaoke. The mixer 124 is used to mix the audio signal 136 and the accompaniment signal 142 so as to form a music signal. The music signal is transmitted to the cellular phones 102A, 102B through the network transmitter 126.

The main point of the present invention is using the network system 100 to provide far-end karaoke service. Therefore, although users of the terminals are located in different places or countries, users also can enjoy karaoke with friends through network system 100. The following illustrates the present invention method of using the network system 100 to provide karaoke service. Before using the karaoke service, users must apply for karaoke service from the server 104. The server 104 has a predetermined account 137. User of the terminals must get this predetermined account 137 (get through the network system) so as to use the karaoke service through the network system 100.

After users get the predetermined account 137, users can use the predetermined account 137 to login to the server 104. For example, user 132A can use the cellular phone 102A to transmit the login signal 139A and the identification signal 152A to the server 104 through the transmitter 112A. When the network receiver 118 of the server 104 receives the login signal 139A transmitted from the terminal 102A, the server 104 compares the login signal 139A with the predetermined account 137 (also can identify the identification signal 152A at the same time). If the login signal 139A matches the predetermined account 137, the cellular phone 102A can use the karaoke service provided by the server 104. If the login signal 139A does not match the predetermined account 137, that means the user of the cellular phone 102A does not have the real predetermined account 137, and the user of the cellular phone 102A cannot use the karaoke service provided by the server 104.

After user 132A has logged in to the karaoke service provided by the server 104, the server 104 can provide service items to the user of the cellular phone 102 according to the identification signal 152A of the cellular phone 102A. The fundamental service item of the present invention server 104 is to use the accompaniment signals 142 inside the database to provide several background music of the karaoke. User 132A can use the controller 108A of the cellular phone 102A to transmit the selection signal 138A so as to select a specific accompaniment signal 142 inside the database 122. As mentioned before, each accompaniment signal 142 corresponds to a specific accompaniment melody (background music). The selection signal 138A is transmitted to the selection circuit 125 of the server 104 through the transmitter 112A and the network receiver 118. The selection circuit 125 selects the specific accompaniment signal 142 according to the selection signal 138A, and then transmits the accompaniment signal 142 to the mixer 124. Finally, the accompaniment signal 142 is transmitted to the receiver 114A of the cellular phone 102A through the network transmitter 126 (according to the identification signal 152A). After receiving the accompaniment signal 142, the receiver 114A transmits the accompaniment signal 142 to the speaker 116A. The speaker 116A transforms the accompaniment signal 142 into the accompaniment melody and plays the melody so that user 132A can hear the accompaniment melody of the accompaniment signal 142 corresponding to the selection signal 138. The accompaniment melody is the background music of the karaoke. Of course, the acoustic wave of user 132A can also be converted into the audio signal 136A through the microphone 106A of the cellular phone 102A. The audio signal 136A is transmitted to the mixer 124 of the server 104 through the transmitter 112A and the network receiver 118. The mixer 124 mixes the audio signal 136A with the accompaniment signal 142 in real-time so as to form a music signal 146. The music signal 146 is transmitted to the speaker 116A through the network transmitter 126 and the receiver 114A. The speaker 116A converts the music signal into the music wave and plays the music wave so that user 132A can simultaneously hear the accompaniment melody 144 and the acoustic wave 134A.

Of course, the main purpose of the present invention is to allow users of several terminals to simultaneously enjoy the karaoke service without the limitation of being in the same location. If user 132B has a login signal 139B matching the predetermined account 137, the cellular phone 102B of user 132B can use the login signal 139B and the identification signal 152B to login the same karaoke service of the server 104. At that time, the server 104 tells each user who uses the same karaoke service that there are two users (and also tells the identity of users because the server 104 receives the identification signal of each login user when users login to the karaoke service). Each user who has logged into the karaoke service can use the controller of the terminals to generate the selection signal. The selection signal is transmitted to the server 104 through the transmitter of each terminal. The server 104 chooses the accompaniment signal 142 from the database 122 according to the selection of each user inside the same karaoke service. The acoustic wave of each user is converted into the audio signal through the microphone of each terminal. The audio signal then is transmitted to the mixer 124 of the server 104. The mixer 124 mixes the audio signal of each user inside the same karaoke service with the accompaniment signal 142 so as to form the music signal 146. The music signal 146 is transmitted back to each terminal through the network transmitter 126. The speaker of each terminal converts the music signal 146 into the music wave. Because the music signal 146 is mixed by the accompaniment signal and the audio signal of each user, users of each terminal can hear the acoustic wave of other users. Since users 132A and 132B of the network system 100 have logged into the same karaoke service, the acoustic wave 134A, 134B of each user is transmitted to the mixer 124 through the corresponding transmitter 112A, 112B and the network receiver 118. The mixer 124 mixes the audio signal of each user with the selected accompaniment signal 142 in real-time so as to form the music signal 146. The music signal 146 is transmitted back to the cellular phones 102A, 102B through the network transmitter 126. The speakers of cellular phones 102A, 102B convert the music signal 146 into music waves and play the music waves. Therefore, although users 132A, 132B are in the different places, they also can simultaneously hear the acoustic wave 134A, 134B of others, as shown in FIG. 2. Therefore, users who have logged into the same karaoke service can sing with the same background music, and can also simultaneously hear the singing sound of other users.

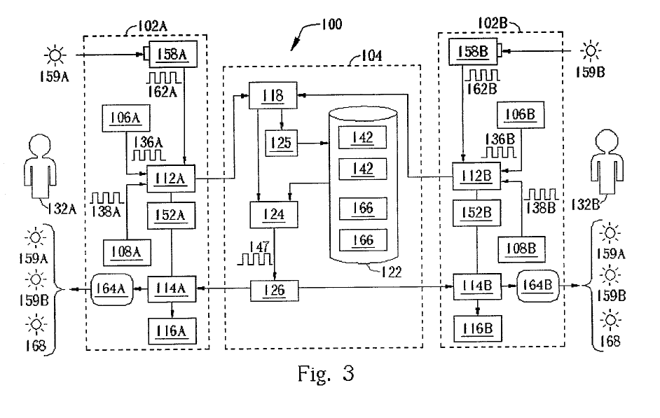

With the progress of optical image technologies, more and more cellular phones, PDAs (Personal Digital Assistants), and personal computers have an image capture device installed. The image shot by the image capture device can be transmitted to the network system 104. If each terminal of the present invention has an image capture device installed, the function of the karaoke service can be improved. Please refer to FIG. 3. FIG. 3 is a perspective view of an image processing method according to the present invention. Besides the function blocks shown in FIG. 2, the cellular phones 102A, 102B of the network system 100 further comprise image capture devices 158A, 158B, and display panels 164A, 164B, respectively, as shown in FIG. 3. The image capture device 158A of the cellular phone 102A can shoot a scene 159A (such as facial expression of user 132A), and convert the scene into a corresponding electronic image signal 162A. The electronic image signal 162A is transmitted to the network receiver 118 through the transmitter 112A. The receiver 114A of the cellular phone 102A can receive the image signal and transmit the image signal to the display panel 164A. The display panel 164A can convert the image signal into the image and display the image. Therefore, user 132A can see the image corresponding to the image signal from the display panel 164A. The image capture device 158B and the display panel 164B of the cellular phone 102B have the same function of the cellular phone 102A. In addition, the network receiver 118 of the server 104 can receive the image signal transmitted from each terminal, and can then transmit the image signals to the mixer 124. In addition to the various accompaniment signals 142, the database 122 further stores a plurality of electronic image data 166. Each image data corresponds to the reference image. Under the karaoke service, each image data 166 corresponds with the reference image of the specific accompaniment melody. The selection circuit 125 can choose not only the accompaniment signal, but can also choose the specific image data and transmit the image data to the mixer 124. The mixer 124 can mix not only the accompaniment signal and the audio signal of each user in real-time, but can also mix the image signal of each user and the image data chosen from the database 122 so as to form an image processing signal. The image processing data is transmitted back to each terminal (according to the identification signal of each terminal) through the network transmitter 126.

The karaoke service, provided by the present invention network system 100 shown in FIG. 3, can mix not only the audio signals with the accompaniment signal, but can also mix the image signal with the image data. Therefore, each user who has logged into the same karaoke service can see the image of others. For example, users 132A and 132B have logged into the same karaoke service. Users 132A, 132B can use the image capture devices 158A, 158B of the terminals (cellular phones 158A, 158B) to shoot scenes 159A, 159B respectively. The image signals 162A, 162B corresponding to the scenes 159A, 159B are transmitted to the mixer 124 through the respective transmitter 112A, 112B and the network receiver 118. Of course, the selection signals of users of each terminal are also transmitted to the selection circuit 125, which is similar to the music mixing process. The selection circuit 125 can choose the corresponding accompaniment signal 142 and the image data 166 according to the selection signal. The image data 166 is mixed with the image signals 162A, 162B in real-time, and transmitted from each terminal (cellular phones 102A, 102B) so as to form an image processing signal 147. The image processing signal 147 is transmitted to the receiver 114A, 114B of each terminal through the network transmitter 126. The display panel of each terminal converts the image processing signal 147 into the image and displays the image. Therefore, users 132A, 132B can see and scene 159A, 159B of each other and the reference image 168 (such as lyrics of a song) corresponding to the image data. The mixed image can be a superimposed image, in which the lyrics of a song (reference image) are on top of the scene of users. The mixed image also can be displayed side by side, in which the scenes 159A, 159B stand side by side. Therefore, the present invention can provide not only the music mixing service, but can also provide the image mixing service. Each user can hear not only the acoustic waves of others, but can only see the scenes of others. Therefore, users can enjoy karaoke service without the limitation of space.

Since each terminal transmits the corresponding identification signal to the network system 100 when terminals are logged into the network system 100, network system 100 can provide specific service to each user. For example, user 132A in FIG. 2 can choose not to listen the acoustic wave of user 132B. In this case, the mixer 124 selectively excludes the acoustic wave (the audio signal 136B) of user 132B, only mixes the accompaniment signal and the audio signal 136A, and then transmits the mixed music to the cellular phone 102A. At the same time, if user 132B wants to hear the acoustics of all users, the mixer 124 can also mix the audio signal of all users with the accompaniment signal by using a multiplexing manner so as to form the music signal, and then transmits the music signal to the cellular phone 102B. Similarly, the mixer 124 also can provide the specific image mixing service to each user. In addition, if the cellular phone 102B shown in FIG. 3 does not have the image capture device 158B installed, the server 104 cannot provide the scene of user 132B, but can still provide the scene 159A of user 132A and reference image 168 to each user. That means, although the equipment of each terminal is different, the server 104 can elastically provide different karaoke services to each user. Of course, it is possible that one of the terminals 102A, 102B shown in FIG. 2 and FIG. 3 is a cellular phone, and another one is a personal computer with video function. Although the equipment of the terminals is different, as long as the terminals can login to the server 104, users of the terminals can enjoy karaoke fun with friends.

In conclusion, the present invention can provide not only the music mixing service, but can also provide the image mixing service. When a group of friends want to enjoy karaoke fun, they can do so without limitations of time, traffic, and place. That means the present invention provides a mobile remote karaoke, which overcomes the problems of traffic, time, and place.

The present invention fully uses the wide communication band provided by 3G, and internet service. The mobile remote karaoke service increases the interaction of users without the limitations of time and place.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A data processing method of a karaoke system based on a network system, the network system comprising:
a first terminal comprising:
a microphone for receiving an input acoustic wave generated from a user of the first terminal and converting the acoustic wave into a corresponding audio signal;
a controller for generating a selection signal according to an instruction made by the user; and
a first transmitter for transmitting signals;
a server comprising:
a network receiver for receiving signals transmitted from the first terminal;
a database for storing a plurality of accompaniment signals, each accompaniment signal corresponding to a specific accompaniment melody;
a mixer for mixing the audio signal with the accompaniment signal; and
a network transmitter for transmitting signals; and
a second terminal comprising:
a second transmitter for transmitting signals;
a receiver for receiving signals transmitted from the network transmitter; and
a speaker for converting the signal received by the receiver into a corresponding output acoustic wave;
the data processing method comprising:
using the first transmitter for transmitting the audio signal and the selection signal to the network receiver of the server;
selecting one of the accompaniment signals out of the database;
using the mixer for mixing the audio signal with the accompaniment signal to generate a corresponding music signal;
using the second transmitter for transmitting a log-in signal and an identification signal corresponding to the second terminal to the network receiver of the server;
comparing the log-in signal and a predetermined account; using the network transmitter for transmitting the music signal to the second terminal according to the identification signal if the log-in signal matches the predetermined account;
using the receiver of the second terminal for receiving the music signal; and
using the speaker of the second terminal for converting the music signal into the output acoustic wave so that a user of the second terminal can hear the input acoustic wave generated by the user of the first terminal and the accompaniment melody generated from the accompaniment signal selected by the user of the first terminal.

2. The data processing method of claim 1 wherein the first terminal further comprises an image capture device for shooting a scene to generate a corresponding image signal, and the second terminal further comprises a display panel for displaying the scene corresponding to the image signal; the data processing method further comprising:
using the first transmitter for transmitting the image signal to the server;
using the network transmitter for transmitting the image signal to the second terminal according to the identification signal corresponding to the second terminal if the log-in signal matches the predetermined account; and
using the display panel of the second terminal for displaying the scene corresponding to the image signal so that the user of the second terminal can watch the scene shot by the image capture device of the first terminal.

3. The data processing method of claim 1 wherein the first terminal further comprises an image capture device for shooting a scene to generate a corresponding image signal, the second terminal further comprises a display panel for displaying the scene corresponding to the image signal, the database of the server further comprises a plurality of image data, each of the image data corresponds to a reference image, and the mixer is further capable of mixing the image datum with the image signal;
the data processing method further comprising:
using the first transmitter for transmitting the image signal to the network receiver of the server;
selecting one of the image data out of the database;
using the mixer for mixing the image datum with the image signal to generate a
corresponding image processing signal;
using the network transmitter for transmitting the image processing signal to the second terminal according to the identification signal corresponding to the second terminal if the log-in signal matches the predetermined account; and
using the display panel of the second terminal for displaying a scene corresponding to the image processing signal so that the user of the second terminal can watch the scene shot by the image capture device of the first terminal and the reference image generated from the image datum selected by the user of the first terminal.

4. The data processing method of claim 1 wherein the first terminal is a cellular phone, and the first transmitter transmits signals to the server via wireless transmission.

5. The data processing method of claim 1 wherein the first terminal is a computer.

6. The data processing method of claim 1 wherein the second terminal is a cellular phone, and the network transmitter of the server transmits signals to the second terminal via wireless transmission.

7. The data processing method of claim 1 wherein the second terminal is a computer.
